(19) United States
(12) Patent Application Publication
(10) Pub. No.: US 2004/0114935 A1
(43) Pub. Date: Jun. 17, 2004

(54) Optical communication device

(75) Inventors: Masahiro Fushimi, Tokyo (JP); Akira Arimoto, Tokyo (JP); Shinji Tsukamoto, Saitama-ken (JP); Tadashi Minakuchi, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/699,675

(22) Filed: Nov. 4, 2003

(30) Foreign Application Priority Data
Nov. 5, 2002 (JP) 2002-320864

(51) Int. Cl. H04B 10/12

(52) U.S. Cl. 398/141

(57) ABSTRACT

An optical communication device includes a light source that emits a light beam for transmitting data, and an optical fiber that has an entrance face through which the light beam emitted from the light source enters the optical fiber. The entrance face has a core region and a cladding region. A beam spot moving mechanism moves a beam spot formed by the light beam emitted from the light source on the entrance face of the optical fiber in first and second directions. A light detector having a light receiving surface detects light amount of the light beam reflected by the entrance face of the optical fiber. The light receiving surface is divided in multiple light detecting areas. A controller controls the beam spot moving mechanism to adjust light amounts detected by the light detecting areas to a predetermined ratio. For example, the controller controls the beam spot moving mechanism so that the light amounts detected by the light detecting areas become the same.

### BACKGROUND OF THE INVENTION

The present invention relates to an optical communication device that transmits modulated laser beam through an optical fiber for data transfer.

An optical communication device generally includes a laser diode for emitting a laser beam modulated in accordance with data to be transferred and a converging lens for converging the laser beam on an entrance face of an optical fiber connected to the optical communication device. In order to efficiently transmit the laser beam through the optical fiber, the laser beam should be converged on the center of the core of the optical fiber's entrance face. This requires very precise positioning of the laser diode and the converging lens against the optical fiber since the core of the optical fiber has a diameter of only a few micrometers while the laser beam has a diameter of about 10 mircometers.

A conventional method for positioning the laser diode and the converging lens against the optical fiber is disclosed in Japanese Patent Provisional Application No. HEI 6-94947. According to the method disclosed, the light amount of the laser beam passed through the optical fiber is detected. The optical fiber is moved relative to the laser beam until the detected light amount becomes its maximum value. When the detected light amount indicates its maximum value, it is determined that the laser beam emitted from the laser diode impinges on the center of the optical fiber's core.

However, since it is difficult to visually distinguish the core of the entrance face of the optical fiber from the cladding, the position of the laser diode relative to the optical fiber must be first adjusted by trial and error until the laser beam enters the core of the optical fiber and can be detected on the other end of the optical fiber. This process is troublesome and time consuming.

After the positioning against the optical fiber is achieved, the laser diode and the converging lens are fixed in the optical communication device by an adhesive, for example. However, since the adhesive contracts during a hardening process thereof, the proper alignment of the laser diode, the converging lens, and the optical fiber can be lost due to the contraction of the adhesive, which, in turn, may cause low production efficiency of the optical communication device.

Further, even if the laser diode and the converging lens are fixed at their proper positions by adhesive, the positions thereof relative to the optical fiber may change with age and cause poor optical coupling between the laser diode and the optical fiber.

Therefore, there is a need for an optical communication device by which the laser diode and the optical fiber can be optically coupled in a short time.

Further, there is also a need for an optical communication device that is capable of keeping the optical coupling between the laser diode and the optical fiber in a good condition over an extended time period.

### SUMMARY OF THE INVENTION

The present invention is advantageous in that an optical communication device that satisfies the above-mentioned needs is provided.

An optical communication device according to an aspect of the invention includes a light source that emits a light beam for transmitting data, and an optical fiber that has an entrance face through which the light beam emitted from the light source enters the optical fiber. The entrance face has a core region and a cladding region. The reflectivity of the cladding region is increased compared to that of the core region at least in a vicinity of the core region by, for example, forming a mirror surface coating on the cladding region by evaporation.

A beam spot moving mechanism moves a beam spot formed by the light beam emitted from the light source on the entrance face of the optical fiber in first and second directions.

The optical communication device further includes a light detector having a light receiving surface for detecting a light amount of the light beam reflected by the entrance face of the optical fiber. The light receiving surface is divided into multiple light detecting areas.

A controller controls the beam spot moving mechanism to adjust light amounts detected by the light detecting areas to have a predetermined ratio. For example, the controller controls the beam spot moving mechanism so that the light amounts detected by the light detecting areas become the same.

Since the position of the light beam incident on the entrance face of the optical fiber is detected based on the light reflected by the entrance face, it is not necessary for the optical communication device arranged as above to introduce the light beam through the optical fiber by trial and error before beginning fine adjustment of the light beam incident position on the optical fiber. Accordingly, the optical communication device can optically couple the light source to the optical fiber in a short time.

Further, in the optical communication device arranged as above, the condition of the optical coupling between the light source and the optical fiber can be checked and re-adjusted also during the use of the optical communication device by detecting the incident position on the optical fiber of the light beam carrying data to be transmitted. Accordingly, the optical communication device can keep the optical coupling between the light source and the optical fiber in a good condition over an extended time period.

Further, since the entrance face of the optical fiber is configured so that the cladding region thereof has higher reflectivity than the core region at least in a vicinity of the core region, the light detector can receive from the cladding region a large amount of light and thereby enhance the accuracy of detecting the incident position of the light beam on the entrance face of the optical fiber. The accurate detection of light beam incident position allows, in turn, the optical communication device to accurately adjust the incident position of light beam on the optical fiber.

Optionally, the light receiving surface may be divided into four light detecting areas by two boundary lines passing through a center of the light receiving surface, and the controller may control the beam spot moving mechanism to adjust light amounts detected by the light receiving surface on both sides of the first boundary line to have a first predetermined ratio and light amounts detected on both sides of the second boundary line to have a second predetermined ratio.

Further optionally, the light detector may be arranged such that a beam spot formed on the light receiving surface by the light beam reflected by the entrance face of the optical fiber moves along the first and second boundary lines as the beam spot moving mechanism moves the beam spot formed on the entrance face of the optical fiber in the first and second direction, respectively.

Alternatively, the light detector may be arranged such that a beam spot formed on the light receiving surfaces by the light beam reflected by the entrance face of the optical fiber moves along lines bisecting corners formed between the first and second boundary lines as the beam spot moving mechanism moves the beam spot formed on the entrance face in the first and second direction.

Optionally, each of the light detecting areas may have an inner zone and an outer zone arranged to receive the light beam reflected at the core region and the cladding region, respectively, and each of the light detecting areas may have a higher sensitivity at the inner zone than at the outer zone so that the light beam reflected by the core region, which has lower reflectivity than the cladding region, can be also detected accurately.

Further optionally, the light amount received by a given one of the light detecting areas is obtained from the following equations,

L=A+αB

α=a/b

where L represents the light amount received by the given one of the light detecting areas, A and B represent the light amount received by the outer and inner zones of the given one of the light detecting areas, respectively, and a and b represent the sensitivity of the inner and outer zones, respectively.

Optionally, the beam spot moving mechanism may include a first converging lens that converges the light beam emitted from the light source on the entrance face of the optical fiber and an actuator that moves the first converging lens in the first and second directions.

Optionally, the optical communication device may further include a second converging lens that converges the light beam reflected at the entrance face of the optical fiber on the light receiving surface of the light detector. The light receiving surface of the light detector and the entrance face of the optical fiber may be arranged so that they are conjugate with respect to the second converging lens to increase the contrast of a beam spot formed on the light receiving surface of the light detector by the laser beam reflected by the entrance surface of the optical fiber.

According to another aspect of the invention, a device for optically coupling a light source to an optical fiber is provided, which includes a holder that holds the optical fiber so that a light beam emitted from the light source impinges on an end face of the optical fiber, a detector that detects displacement of an incident position of the laser beam on the end face of the optical fiber from a predetermined position on the end face based on the light beam reflected by the end face; and an adjuster that adjusts the incident position of the light beam on the end face of the optical fiber based on an output from the detector.

According to still another aspect of the invention, a method for positioning a light incident on an entrance face of an optical fiber in an optical communication device for transmitting data through the optical fiber is provided. This method includes, detecting light reflected at the entrance face of the optical fiber by a light detector having a light detecting surface divided into a plurality of light amount detecting areas by a plurality of boundary lines each passing through a center of the light detecting surface, and positioning light incident on the entrance face of the optical fiber so that the light amount detecting areas detect light amounts in a predetermined ratio.

### BRIEF DESCRIPTION OF THE ACCOMPANYING DRAWINGS

FIG. 1 schematically illustrates a configuration of an optical communication module according to an embodiment of the invention;

FIG. 2 schematically illustrates a configuration of a light receiving surface of a light detector provided to the optical communication module shown in FIG. 1;

FIGS. 3A, 3B, and 3C show examples of positions of a beam spot formed on the light receiving surface of the light detector;

FIG. 4 shows a relation between a beam spot position on the light receiving surface and a difference of light amount detected on each half of the light receiving surface;

FIG. 5 schematically illustrates an end face of an optical fiber;

FIG. 6 shows a variation of the optical communication module shown in FIG. 1; and

FIGS. 7, 8, and 9 schematically illustrate other variations of the optical communication module shown in FIG. 1.

### DETAILED DESCRIPTION OF THE EMBODIMENTS

Hereinafter, an optical communication module 10 according to an embodiment of the present invention will be described with reference to the accompanying drawings.

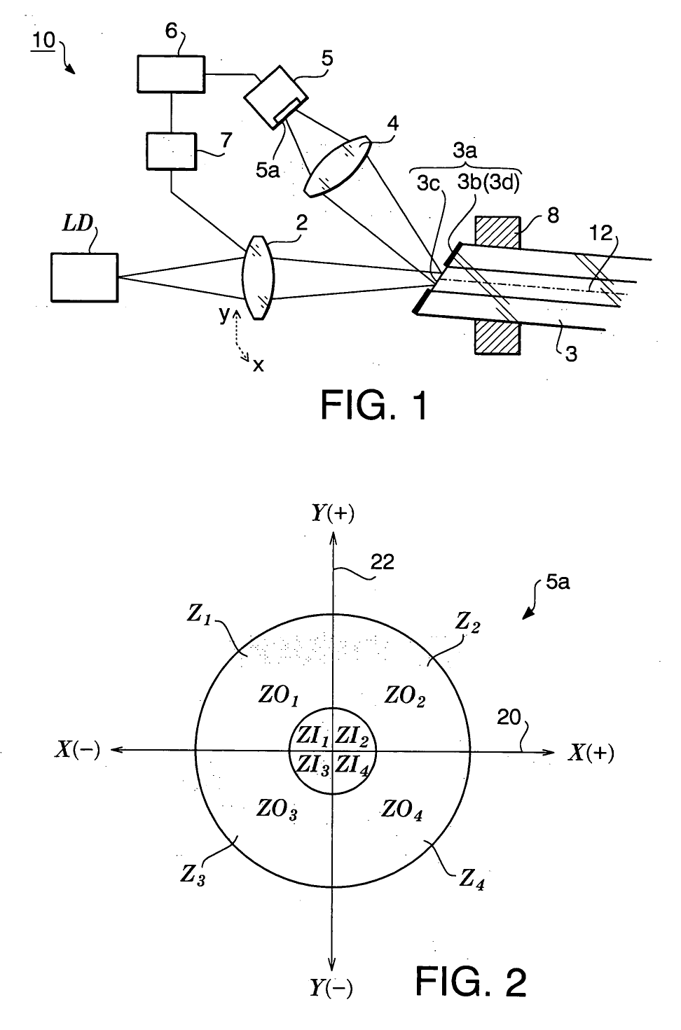

FIG. 1 schematically illustrates a configuration of the optical communication module 10 according to the embodiment of the invention. The optical communication module 10 according to the present embodiment can be utilized, for example, as an optical network unit (ONU) that connects a terminal such as a subscriber's computer with an optical fiber network. The optical communication module 10 is designed with a wavelength division multiplexing (WDM) technology that transports bi-directional signal over a single optical fiber. The optical communication module 10 utilizes light of which wavelength is 1.3 μm for transmitting data and light of which wavelength is 1.5 μm for receiving data.

As shown in FIG. 1, the optical communication module 10 is provided with a laser diode LD, a first converging lens 2, a second converging lens 4, a light detector 5, a controller 6 and an actuator 7.

The laser diode LD is a light source generating the light for data transmission. The laser diode LD emits a laser beam that is modulated in accordance with data to be transmitted over an optical fiber 3 connected to the optical communication device 10.

The first converging lens 2 is placed on the optical path of the laser beam emitted from the laser diode LD, and converges the laser beam on an end face, or entrance face 3a, of the optical fiber 3.

A part of the laser beam incident on the entrance face 3a of the optical fiber 3 enters the optical fiber 3 and transmits therethrough to a receiving device, while the remaining part of the laser beam is reflected by the entrance face 3a.

The entrance face 3a of the optical fiber 3 is formed obliquely against the center axis 12 of the optical fiber 3, and the optical fiber 3 is held by a fiber holding mechanism 8 of the optical communication module 10 so that the entrance face 3a is inclined against the laser beam incident thereon and reflects the laser beam toward the light detector 5.

The entrance face 3a of the optical fiber 3 has a core region 3c and a cladding region 3b corresponding to the core and cladding of the optical fiber 3, respectively. In the present embodiment, the center of the core region 3c coincides with the center of the entrance face 3a. The cladding region 3b is provided with a mirror surface coating 3d formed by means of evaporation, for example, substantially over the whole area thereof. The mirror surface coating 3d is provided on the cladding region 3b in order to enhance the reflectivity thereof and thereby improve the accuracy of light amount detection of the light detector 5.

The second converging lens 4 is placed between the entrance face 3a of the optical fiber 3 and the light detector 5 so that the entrance face 3a and a light receiving surface 5a of the light detector 5 are conjugate with respect to the second converging lens, and so that the center of the entrance face 3a and the center of the light receiving surface 5a are on the optical axis of the second converging lens 4.

The laser beam reflected by the entrance face 3a is converged on the light receiving surface 5a and forms a beam spot thereon. The light detector 5 detects the position of that beam spot. Since the entrance face 3a and the light receiving surface 5a are conjugate with respect to the second converging lens 4, the beam spot has a high contrast and this high contrast of the beam spot allows the light detector 5 to detect the position of the beam spot accurately.

The light detector 5 outputs a signal corresponding to the position of the beam spot on the light receiving surface 5a to the controller 6 which controls the actuator 7.

The actuator 7 adjusts the position of the first converging lens 2 within an adjustment plane that is perpendicular to the optical axis of the first converging lens 2. In the present embodiment, the actuator 7 is arranged to move the first converging lens 2 in two directions, i.e. x and y directions, that are orthogonal to each other and parallel to the adjustment plane. Note that when the first converging lens 2 is moved within the adjustment plane, a beam spot formed on the entrance face 3a of the optical fiber 3 by the laser beam incident thereon also moves on the entrance face 3a. Thus, the incident position of the laser beam on the entrance face 3a can be adjusted by adjusting the position of the first converging lens 2 within the adjustment plane.

The actuator 7, and hence the position of the first converging lens 2, is controlled by the controller 6 in accordance with the signal received from the light detector 5. The controller 6 controls the position of the first converging lens 2 so that the laser beam impinges on the entrance face 3a substantially at the center thereof.

In the present embodiment, the light receiving surface 5a of the light detector 5 is divided into a plurality of areas so that the light detector 5 can determine the position of the beam spot formed on the light receiving surface 5a. FIG. 2 schematically illustrates the configuration of the light receiving surface 5a of the light detector 5.

As shown in FIG. 2, the light receiving surface 5a is divided in four light detecting areas Z₁, Z₂, Z₃, and Z₄ by first and second boundary lines 20 and 22. In the present embodiment, the light receiving surface 5a has a round shape. The first and second boundary lines 20 and 22 are orthogonal to each other and pass through the center of the round light receiving surface 5a. Accordingly, the light receiving surface 5a is divided in quarters by the first and second boundary lines 20 and 22. It should be noted, however, that dividing the light receiving surface 5a into equal parts is not essential for the present embodiment. The light receiving surface 5a may also be divided into non-equal parts by non-orthogonal boundary lines.

The light detector 5 is placed in the optical communication module 10 such that the beam spot formed by the laser beam on the light receiving surface 5a moves along the first boundary line 20, or in X direction, when the first converging lens 2 is moved in the x direction by the actuator 7 to adjust the incident position of the laser beam on the entrance face 3a, and such that the beam spot on the light receiving surface 5a moves along the second boundary line 22, or in Y direction, when the first converging lens 2 is moved in the y direction.

Each of the light detecting areas Z₁, Z₂, Z₃, and Z₄ includes an outer zone (ZO₁, ZO₂, ZO₃, ZO₄) and an inner zone (ZI₁, ZI₂, ZI₃, ZI₄). The outer (ZO₁, ZO₂, ZO₃, ZO₄) and the inner zones (ZI₁, ZI₂, ZI₃, ZI₄) are arranged such that the laser beam reflected by the cladding region 3b of the entrance face 3a impinges on the outer zones (ZO₁, ZO₂, ZO₃, ZO₄) while the laser beam reflected by the core region 3c impinges on the inner zones (ZI₁, ZI₂, ZI₃, ZI₄).

It should be noted that the intensity of the laser beam incident on the inner zones (ZI₁, ZI₂, ZI₃, ZI₄) is smaller than that of the laser beam incident on the outer zones (ZO₁, ZO₂, ZO₃, ZO₄) since the core region 3c of the entrance face 3 is not provided with a mirror surface coating and hence the reflectivity thereof is smaller than that of the cladding region 3b. Therefore, in order to accurately detect the light amount of laser beam reflected by the core region 3c, the light detecting areas (Z₁, Z₂, Z₃, Z₄) are arranged such that the inner zones (ZI₁, ZI₂, ZI₃, ZI₄) have higher sensitivity than the outer zones (ZO₁, ZO₂, ZO₃, ZO₄). In the present embodiment, the sensitivity of the inner zones and outer zones are adjusted so that the ratio of the inner zone sensitivity to the outer zone sensitivity coincides with the ratio of the reflectivity of the optical fiber's entrance face 3a at the cladding region 3b to that at the core region 3c.

The light detector 5 determines the light amount of the laser beam incident on each light detecting area (Z₁, Z₂, Z₃, Z₄) based on the following equations:

Lᵢ=Aᵢ+αBᵢ (1)

α=aᵢ/bᵢ (2)

where Lᵢ represents the total light amount of the laser beam incident on the i-th light detecting area, Aᵢ and Bᵢ respectively represent the light amount of the laser beam incident on the outer and inner zones of the i-th light detecting area. aᵢ and bᵢ respectively represent the sensitivity of the inner and outer zones of the i-th light detecting area.

The light detector 5 outputs data indicating the light amounts Lᵢ detected by each light detecting area (Z₁, Z₂, Z₃, Z₄) to the controller 6. The controller 6 determines whether or not and in which direction the beam spot formed on the light receiving surface 5a of the light detector 5 is displaced from the center of the light receiving surface 5a in each of the X and Y directions.

Specifically, the light detector 5 determines whether the beam spot is displaced in the X axis direction from the difference between the light amounts incident on one side of the second boundary line 22 and on the other side thereof. In the present embodiment, the difference between the above-mentioned light amounts, Lₓ, can be determined based on the following equation:

Lₓ=(L₁+L₃)−(L₂+L₄) (3)

where, L₁, L₂, L₃, and L₄ represent the light amounts of the laser beam incident on the light detecting areas Z₁, Z₂, Z₃, and Z₄, respectively.

Assuming that a positive X direction is right and a negative X direction is left in FIG. 2, Lₓ having a positive value indicates that the beam spot is displaced in the negative X direction from the center of the light receiving surface 5a. On the contrary, Lₓ having a negative value indicates that the beam spot is displaced in the positive X direction from the center of the light receiving surface 5a.

The displacement of the beam spot in the Y axis direction is determined from the difference between the light amounts incident on one side of the first boundary line 20 and on the other side thereof, which can be obtained from the following equation:

L_{y}=(L₃+L₄)−(L₁+L₂) (4)

Assuming that a positive Y direction is up and a negative Y direction is down in FIG. 2, L_{y} having a negative value indicates that the beam spot is displaced in the positive Y direction from the center of the light receiving surface 5a. On the contrary, L_{y} having a positive value indicates that the beam spot is displaced in the negative Y direction from the center of the light receiving surface 5a.

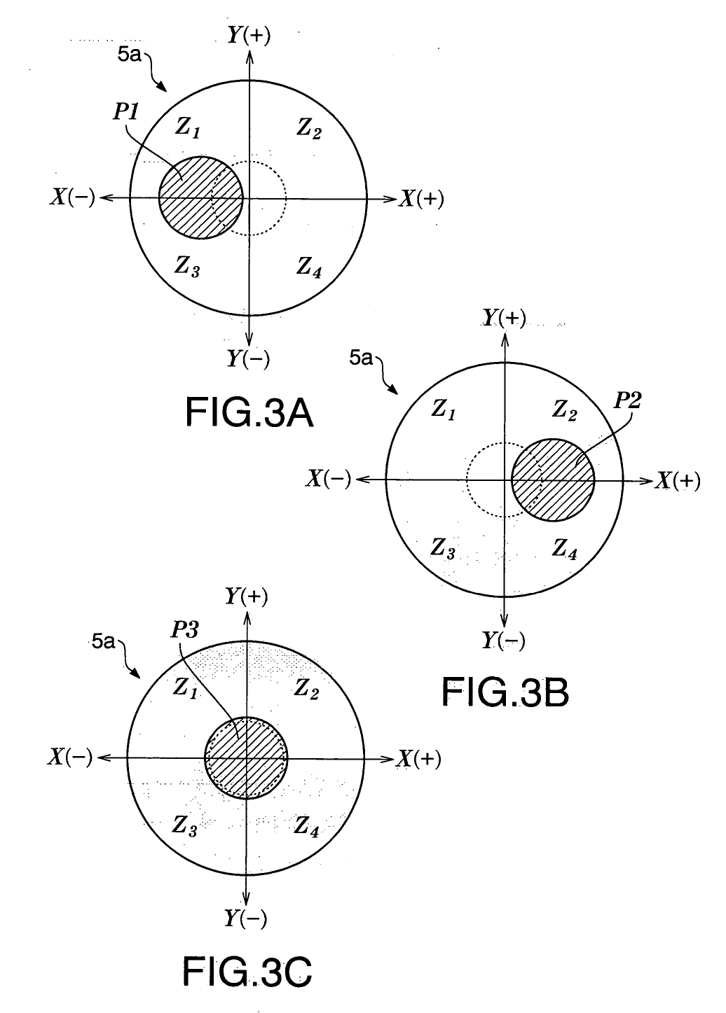

FIGS. 3A, 3B, and 3C show examples of the positions of the beam spot formed on the light receiving surface 5a of the light detector 5 by the laser beam reflected by the entrance face 3a of the optical fiber 3. The broken line in each of FIGS. 3A, 3B, and 3C, indicates the boundary between the inner zones (ZI₁, ZI₂, ZI₃, ZI₄) and the outer zones (ZO₁, ZO₂, ZO₃, ZO₄). The diagonally shaded areas P1, P2, and P3 indicate the beam spot formed on the light receiving surface 5a.

In FIG. 3A, the beam spot P1, or the incident position of the laser beam, is displaced from the center of the light receiving surface 5a in the negative X direction. On the contrary, in FIG. 3B, the beam spot P2 is displaced from the center of the light receiving surface 5a in the positive X direction. Note that, both beam spots P1 and P2 are not displaced from the center of the light receiving surface 5a in the Y direction. FIG. 3C illustrates the beam spot P3 formed by the laser beam incident on the center of the light receiving surface 5a.

As previously described, the entrance face 3a of the optical fiber 3 and the light receiving surface 5a of the light detector 5 are conjugate with respect to the second converging lens 4. Accordingly, the position of each beam spots P1, P2, and P3 on the light receiving surface 5a corresponds to the position on the entrance face 3a on which the laser beam is incident. The beam spot P3 being on the center of the light receiving surface 5a indicates that the laser beam impinges on the entrance face 3a of the optical fiber at the center thereof, or the center of the core region 3c. The beam spot P1 and P2, both displaced from the center of the light receiving surface 5a, indicate that the position of the laser beam incident on the optical fiber's entrance face 3a is displaced from the center thereof.

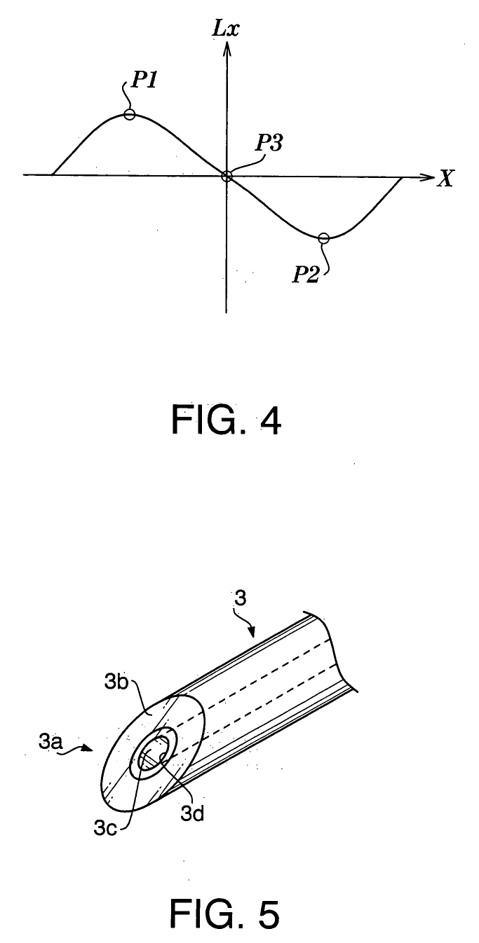

FIG. 4 shows the relation between the beam spot position on the light receiving surface 5a in the X direction and the light amount difference Lₓ obtained from equation (3).

When the beam spot is displaced in the negative X direction from the center of the light receiving surface 5a, the laser beam impinges more on the light detecting areas Z₁ and Z₃ than on the light detecting areas Z₂ and Z₄, resulting in (L₁+L₃)>(L₂+L₄) and hence a positive value of Lₓ.

On the contrary, when the beam spot is displaced in the positive X direction from the center of the light receiving surface 5a, the light amount difference Lₓ indicates a negative value since the laser beam impinges more on the light detecting areas Z₂ and Z₄ than on the light detecting areas Z₁ and Z₃.

Further, when the beam spot has the center thereof on the second boundary line 22, such as the beam spot P3 of FIG. 3C, the light amount difference Lₓ becomes zero.

When the light amount difference Lₓ takes a positive value, which indicates a displacement of the beam spot in the negative X direction from the center of the light receiving surface 5a, the controller 6 drives the actuator 7 to move the first converging lens 2 in the x direction so that the beam spot on the light receiving surface 5a of the light detector 5 moves in the positive X direction until the light amount difference Lx becomes zero. With this, the displacement of the beam spot in the negative X direction can be eliminated.

For example, when the beam spot is located at position P1 as shown in FIG. 3A, the laser beam is incident only on the light detecting areas Z₁ and Z₃ and not on the light detecting areas Z₂ and Z₄. Thus, (L₂+L₄) is zero and hence the light amount difference Lₓ takes its maximum value as shown in FIG. 4. In this case, the controller 6 controls the position of the first converging lens 2 so that the beam spot on the light receiving surface 5a moves in the positive X direction until the light amount difference Lₓ becomes zero, or the beam spot is located at position P3 shown in FIG. 3C.

When the light amount difference Lₓ takes a negative value, which indicates a displacement of the beam spot in the positive X direction from the center of the light receiving surface 5a, the controller 6 moves the first converging lens 2 so that the beam spot on the light receiving surface 5a moves in the negative X direction until the light amount difference Lₓ becomes zero. With this, the displacement of the beam spot in the positive X direction can be eliminated.

For example, when the beam spot is located at position P2 as shown in FIG. 3B, the laser beam is incident only on the light detecting areas Z₂ and Z₄ and not on the light detecting areas Z₁ and Z₃. Thus, (L₁+L₃) is zero and hence the light amount difference Lₓ takes its minimum value as shown in FIG. 4. In this case, the controller 6 controls the position of the first converging lens 2 so that the beam spot on the light receiving surface 5a moves in the negative X direction until the light amount difference Lₓ becomes zero, i.e., until the beam spot is located at position P3.

The position of the beam spot on the light receiving surface 5a in the Y direction is adjusted based on the light amount difference L_{y} obtained from equation (4) in a similar manner as described above in connection with the X direction. That is, when the light amount difference L_{y} takes a positive value (i.e., (L₃+L₄)>(L₁+L₂)), the controller 6 controls the position of the first converging lens 2 so that the beam spot on the light receiving surface 5a moves in the positive Y axis direction until the light amount difference L_{y} becomes zero. On the contrary, if the light amount difference L_{y} indicates a negative value (i.e., (L₃+L₄)<(L₁+L₂)), the controller 6 moves the first converging lens 2 so that the beam spot on the light receiving surface 5a moves in the negative Y axis direction until the light amount different L_{y} becomes zero.

When the position of the beam spot on the light receiving surface 5a is adjusted such that both of the light amount differences Lₓ and L_{y} are zero, the beam spot is located at the center of the light receiving surface 5a, and thus the laser beam emitted from the laser diode LD impinges on the center of the entrance face 3a of the optical fiber, or the center of the core region 3c.

As described above, the position of the beam spot on the light receiving surface 5a of the light detector 5 is controlled by a negative feedback process that operates so as to make each of the light amount differences Lₓ and L_{y} zero. This negative feedback process allows the optical communication module 10 to adjust the incident position of the laser beam on the entrance face 3a of the optical fiber 3 at the center of the core region 3c automatically and accurately.

It should be noted that although the adjustment of the position of the beam spot on the light receiving surface 5a in the X direction and in the Y direction has been separately described, the adjustment is carried out simultaneously in the X and Y directions in the actual optical communication module 10.

It should be also noted that the above-mentioned adjustment of the incident position of the laser beam on the entrance face 3a of the optical fiber is carried out not only at the time of tuning-up the optical communication module 10 just after it is produced, but also whenever the optical communication module 10 is in communication by utilizing the laser beam being modulated in accordance with data to be transmitted. Accordingly, in the optical communication module 10 according to the present embodiment, the optical coupling efficiency between the laser diode and the optical fiber does not decrease with age.

While the invention has been described in detail with reference to a specific embodiment thereof, it would be apparent to those skilled in the art that various changes and modifications may be made therein without departing from the spirit of the invention.

For example, the position of the beam spot on the light receiving surface 5a of the light detector 5 may be adjusted by comparing the light amounts detected at each light detecting area (Z₁, Z₂, Z₃, Z₄) and moving the beam spot so that those light amounts become equal to each other. This can be achieved, for example, in the following manner. First, the light amounts L₁ and L₂ detected by the light detecting areas Z₁ and Z₂, respectively, are compared and the position of the beam spot is adjusted by moving the first converging lens 2 so that the light amounts L₁ and L₂ become equal. Then, the same process is carried out at least for the light detecting areas Z₂ and Z₃, and, for the light detecting areas Z₃ and Z₄.

Further, although the light detector 5 in the embodiment described above is arranged such that the beam spot on the light receiving surface 5a moves along the first and second boundary lines 20 and 22 as the first converging lens 2 is moved in x and y directions, respectively, the light detector 5 may also be arranged such that the beam spot moves along lines that are inclined against the first and second boundary lines 20 and 22 as the first converging lens is moved in the x and y directions. For example, the light detector 5 may be arranged such that the beam spot moves along lines each inclined against the first and second boundary lines 20 and 22 at an angle of 45 degrees. This arrangement provides the advantage that the light amounts detected by the light detecting areas arranged diagonally opposite to each other in the light detector 5 can be adjusted to the same by simply moving the first converging lens in the x or y direction.

Further, although the light detector 5 in the embodiment described above is located such that light receiving surface 5a thereof and the entrance face 3a of the optical fiber 3 are conjugate with respect to the second converging lens 4, the light detector 5 may also be located such that the light receiving surface 5a and the entrance face 3a are not conjugate with respect to the second converging lens 4.

In the embodiment described above, the light detector 5 is configured so that all outer zones (ZO₁, ZO₂, ZO₃, ZO₄) of the light receiving surface 5a have the same sensitivity and also so that all inner zones (ZI₁, ZI₂, ZI₃, ZI₄) have the same sensitivity. However, the outer zones (ZO₁, ZO₂, ZO₃, ZO₄) may have different sensitivity to each other and the inner zones (ZI₁, ZI₂, ZI₃, ZI₄) may also have different sensitivity to each other. Even in such cases, the beam spot position can be estimated based on the detection of the light detector 5 by taking into account the sensitivity of each outer zones (ZO₁, ZO₂, ZO₃, ZO₄) and each inner zones (ZI₁, ZI₂, ZI₃, ZI₄).

In the embodiment described above, the mirror surface coating 3d for enhancing the reflectivity is provided on the entrance face 3a of the optical fiber 3 substantially over the whole cladding region 3b. However, if the fiber holding mechanism 8 reliably holds the optical fiber 3 so that the laser beam emitted from the laser diode LD impinges on the entrance face 3a in a vicinity of the core region 3c, the mirror surface coating 3d may be formed only in the vicinity of the core region 3d in an annular shape, as shown in FIG. 5, instead of over the entire cladding region 3b.

In the embodiment described above, the sensitivity of the inner zones (ZI₁, ZI₂, ZI₃, ZI₄) of the light detector's light receiving surface 5a is increased compared to the sensitivity of the outer zones (ZO₁, ZO₂, ZO₃, ZO₄) in order to detect the laser beam reflected by the core region 3c of the optical fiber's entrance face 3a, which is not provided with the mirror surface coating 3d. However, if the inner zones can accurately detect the. laser beam reflected by the core region 3c of the entrance face 3a, it is not necessary to increase the sensitivity of the inner zones. In this case, the equations for obtaining the light amount incident on the ith light detecting area Zᵢ (i=1, 2, 3, 4), i.e. equations (1) and (2), may be modified as followings:

Lᵢ=Aᵢ+βBᵢ (5)

β=d/c (6)

where c and d respectively represent the reflectivity at the core region 3c and cladding region 3b (or mirror surface coating 3d) of the optical fiber's entrance face 3a.

In the embodiment described above, the position of the laser beam incident on the entrance face 3a of the optical fiber 3 is adjusted by moving the first converging lens 2. The incident position of the laser beam, however, may be adjusted by any other suitable methods. For example, the incident position of the laser beam may be adjusted by moving the laser diode LD.

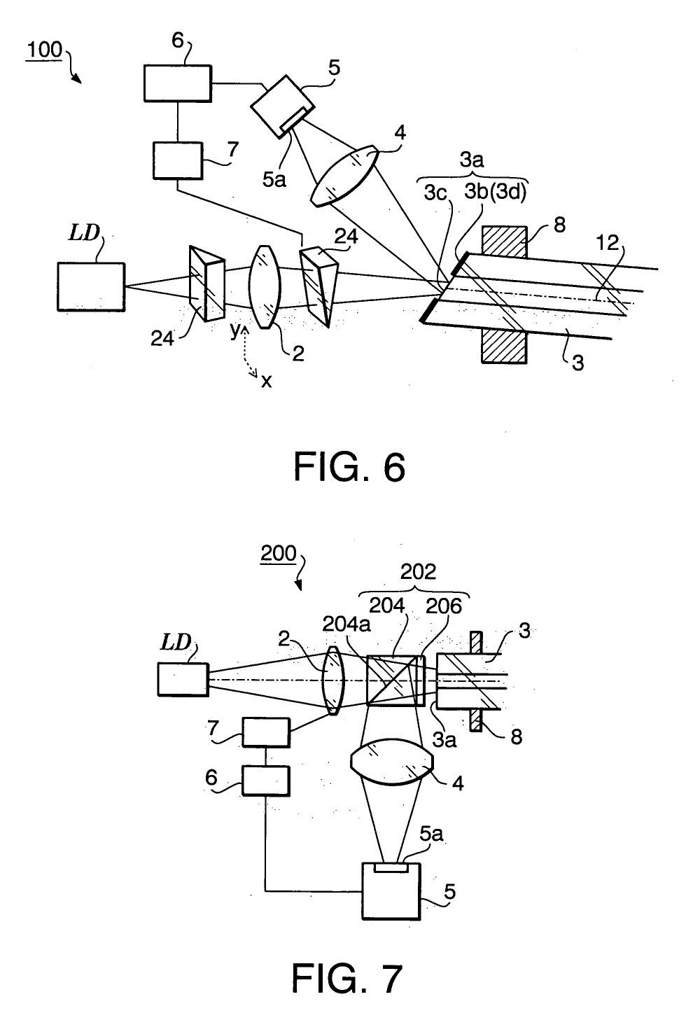

Alternatively, the incident position of the laser beam may be adjusted by one or more transmissive light deflectors placed between the laser diode LD and the optical fiber 3. One example of the transmissive light deflectors is a pair of variable angle prisms 24 arranged as shown in FIG. 6. That is, one of the variable angle prisms 24 is located between the laser diode LD and the first converging lens 2 and the other one between the first converging lens 2 and the optical fiber 3. One of the variable angle prisms 24 controls the direction of the laser beam in the x direction and the other one in the y direction.

It should be noted that, instead of the arrangement shown in FIG. 6, the pair of the variable angle prisms 24 may also be disposed such that both of them are placed between the laser diode LD and the first converging lens 2, or between the first converging lens 2 and the optical fiber 3.

It should be also noted that, the pair of the variable angle prisms 24 shown in FIG. 6 may be replaced with a single prism unit or a single optical element that functions alike the pair of variable angle prisms 24.

FIG. 7 schematically illustrates a configuration of an optical communication module 200 which is a variation of the optical communication module 100 shown in FIG. 1.

In the optical communication module 200 shown in FIG. 7, the laser diode LD and the first converging lens 2 are so arranged that the laser beam reflected back by the entrance face 3a of the optical fiber 3 travels along the optical path of the laser beam incident on the entrance face 3a.

A light deflector 202 is disposed on the optical path of the laser beam between the first converging lens 2 and the optical fiber 3. The deflector 202 allows the laser beam traveling toward the optical fiber 3 to pass therethrough but deflects the laser beam reflected by the entrance face 3a of the optical fiber 3 toward the light detector 5. The laser beam deflected by the light deflector 202 is converged by the second converging lens 4 on the light receiving surface 5a of the light detector 5.

The light deflector 202 includes a beam splitter 204 and a quarter-wave plate 206 attached on a side of the beam splitter 204 facing the entrance face 3a of the optical fiber 3. The laser beam traveling from the laser diode LD to the optical fiber 3 passes through the beam splitter 204, and hence a half mirror 204a of the beam splitter 204, and then the quarter-wave plate 206 which rotates the plane of polarization of the laser beam by 45 degrees.

Then the laser beam impinges on the entrance face 3a of the optical fiber 3. A part of the laser beam is reflected back by the entrance face 3a. The reflected laser beam travels back toward the light deflector 202 and passes through the quarter-wave plate 206 for the second time. Thus, the plane of polarization of the laser beam is rotated by another 45 degrees and the total rotation angle of the polarization plane becomes 90 degrees.

Next, the laser beam strikes the half mirror 204aof the beam splitter 204. Since the polarization plane of the laser beam is rotated by 90 degrees, the laser beam can not pass through the half mirror 204a but is reflected toward the light detector 5. Thus, the light detector 5 can receive the laser beam reflected by the entrance face 3a of the optical fiber 3 and detect the position of the laser beam incident on the entrance face 3a.

It should be noted that the configuration of the optical communication module 200 other than that mentioned above is substantially the same as that of the optical communication module 100 shown in FIG. 1.

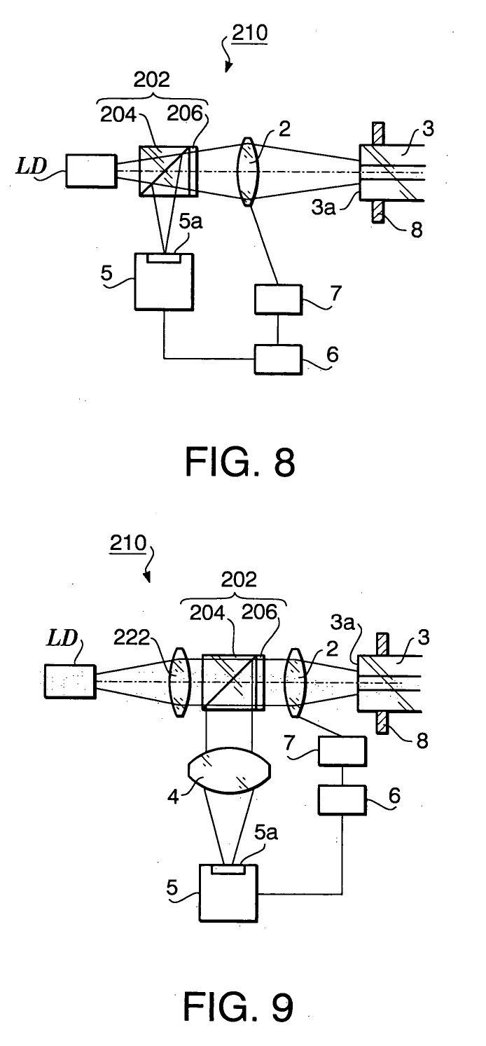

FIG. 8 schematically illustrates a configuration of an optical communication module 210 which is a further variation of the optical communication module 200 shown in FIG. 7. In the optical communication module 210, the light deflector 202 is disposed between the laser diode LD and the first converging lens 2 instead of between the first converging lens 2 and the optical fiber 3. This arrangement is advantageous in that the second converging lens 4 is not necessary and can be eliminated.

Note that the configuration of the optical communication module 210 shown in FIG. 8 is substantially the same as that of the optical communication module 200 shown in FIG. 7 except the above.

FIG. 9 schematically illustrates a configuration of an optical communication module 220 which is another variation of the optical communication module 200 shown in FIG. 7. The optical communication module 220 shown in FIG. 9 has substantially the same configuration as the optical communication module 200 except the followings.

In the optical communication module 220, an additional collimator lens 222 is disposed between the laser diode LD and the first converging lens 2, which collimator lens 222 converts the diverging light beam emitted from the laser diode LD into a parallel light beam.

The light deflector 202 is disposed between the collimator lens 222 and the first converging lens 2. Thus, in the optical communication module 220, the laser beam emitted from the laser diode LD is first collimated by the collimator lens, passed through the light deflector 202, and then converged by the first converging lens 2 on the entrance face 3a of the optical fiber 3. Then, a part of the laser beam is reflected by the entrance face 3a, passed through the first converging lens 2, and then deflected by the light deflector 202 toward the second converging lens 4 which converges the laser beam on the light receiving surface 5a of the light detector 5.

The present disclosure relates to the subject matter contained in Japanese Patent Application No. P2002-320864, filed on Nov. 5, 2002, which is expressly incorporated herein by reference in its entirety.

What is claimed is:

1. An optical communication device, comprising:
a light source that emits a light beam for transmitting data;
an optical fiber having an entrance face through which the light beam emitted from said light source enters said optical fiber, said entrance face having a core region and a cladding region, said cladding region having higher reflectivity than said core region at least at an area defined in a vicinity of said core region;
a beam spot moving mechanism that moves a beam spot formed by the light beam emitted from said light source on said entrance face of said optical fiber in first and second directions;
a light detector having a light receiving surface for detecting a light amount of the light beam reflected by said entrance face of said optical fiber, said light receiving surface being divided into multiple light detecting areas; and
a controller that controls said beam spot moving mechanism to adjust light amounts detected by said light detecting areas to have a predetermined ratio.

2. The optical communication device according to claim 1,
wherein said light receiving surface is divided into four light detecting areas by two boundary lines passing through a center of said light receiving surface, and
wherein said controller controls said beam spot moving mechanism to adjust light amounts detected by said light receiving surface on both sides of said first boundary line to have a first predetermined ratio and light amounts detected on both sides of said second boundary line to have a second predetermined ratio.

3. The optical communication device according to claim 2, wherein said light detector is arranged such that a beam spot formed on said light receiving surface by the light beam reflected by said entrance face of said optical fiber moves along said first and second boundary lines as said beam spot moving mechanism moves the beam spot formed on said entrance face of said optical fiber in the first and second direction, respectively.

4. The optical communication device according to claim 2, wherein said light detector is arranged such that a beam spot formed on said light receiving surfaces by the light beam reflected by said entrance face of said optical fiber moves along lines bisecting corners formed between said first and second boundary lines as said beam spot moving mechanism moves the beam spot formed on said entrance face in the first and second direction.

5. The optical communication device according to claim 2, wherein said controller controls said beam spot moving mechanism so that the light amounts detected by said light detecting areas become the same.

6. The optical communication device according to claim 2, wherein each of said light detecting areas has an inner zone and an outer zone arranged to receive the light beam reflected at said core region and said cladding region, respectively, and
wherein each of said light detecting areas has a higher sensitivity at said inner zone than at said outer zone.

7. The optical communication device according to claim 6, wherein the light amount received by a given one of said light detecting areas is obtained from the following equations,
L=A+αB
α=a/b
where L represents the light amount received by said given one of said light detecting areas, A and B represent the light amount received by said outer and inner zones of said given one of said light detecting areas, respectively, and a and b represent the sensitivity of said inner and outer zones, respectively.

8. The optical communication device according to claim 1, wherein said beam spot moving mechanism includes:
a first converging lens that converges the light beam emitted from said light source on said entrance face of said optical fiber; and
an actuator that moves said first converging lens in the first and second directions.

9. The optical communication device according to claim 8, further comprising a second converging lens that converges the light beam reflected at said entrance face of said optical fiber on said light receiving surface of said light detector,
wherein said light receiving surface and said entrance face are conjugate with respect to said second converging lens.

10. The optical communication device according to claim 1,
wherein each of said light detecting areas is paired with another one of said light detecting areas, and
wherein said controller controls said beam spot moving mechanism to adjusts light amounts detected by said light detecting areas to have a predetermined ratio by adjusting the light amount detected by each of said light detecting areas in accordance with the light amount detected by said light detecting area paired therewith.

11. The optical communication device according to claim 1, wherein said area of said cladding region having higher reflectivity is provided with a mirror surface coating formed by evaporation.

12. A device for optically coupling a light source to an optical fiber, comprising:
a holder that holds the optical fiber so that a light beam emitted from the light source impinges on an end face of the optical fiber;
a detector that detects displacement of an incident position of the laser beam on the end face of the optical fiber from a predetermined position on the end face based on the light beam reflected by the end face; and
an adjuster that adjusts the incident position of the light beam on the end face of the optical fiber based on an output from said detector.

13. The device according to claim 12,
wherein said detector has a plurality of light detecting areas that detect light amounts of the light beam incident thereon, and
wherein said light detecting areas are arranged so that the light amounts are detected in a predetermined ratio when the light beam is incident on the predetermined position of the end face of the optical fiber.

14. The device according to claim 13, wherein said light detecting areas are arranged so that light amounts detected by said light detecting areas are the same when the light beam emitted from the light source is incident on the predetermined position of the end face of the optical fiber.

15. The device according to claim 14,
wherein said detector has a light receiving surface divided into quarters by first and second boundary lines to define four light detecting areas that detect amounts of light incident thereon, and
wherein said detector is disposed so that the light beam reflected by the end face of the optical fiber at the predetermined position thereof impinges on a point of intersection of said first and second boundary lines.

16. The device according to claim 15,
wherein said adjuster adjusts the incident position of the light beam on the end face of the optical fiber by shifting an optical path of the light beam in first and second directions, and
wherein said detector is disposed so that the incident position of the light beam on said light receiving surface shifts in parallel with said first and second boundary lines as said adjuster shifts the optical path of the light beam in said first and second directions.

17. The device according to claim 15,
wherein each of said light detecting areas includes inner and outer zones that respectively receive the light beam reflected by a core region and a cladding region of the end face of the optical fiber, and
wherein said inner zone has higher sensitivity than said outer zone.

18. The device according to claim 12,
wherein said adjuster includes a light beam converging lens that converges the light beam emitted from the light source on the end face of the optical fiber, and
wherein the incident position of the light beam on the end face of the optical fiber is adjusted by moving said light beam converging lens.

19. The device according to claim 12, further comprising a reflected light converging lens that converges the light beam reflected by the end face of the optical fiber on a light receiving surface of the light position detector,
wherein said reflected light converging lens is disposed so that said light receiving surface of the light position detector and the end face of the optical fiber are conjugate with said reflected light converging lens.

20. A method for positioning light incident on an entrance face of an optical fiber in an optical communication device for transmitting data through the optical fiber, comprising:
detecting light reflected at the entrance face of the optical fiber by a light detector having a light detecting surface divided into a plurality of light amount detecting areas by a plurality of boundary lines each passing through a center of the light detecting surface; and
positioning light incident on the entrance face of the optical fiber so that the light amount detecting areas detect light amounts in a predetermined ratio.
